(19) United States
(12) Patent Application Publication
(10) Pub. No.: US 2026/0368461 A1
(43) Pub. Date: Nov. 19, 2026

(54) Agentive QR+ Identity and Interaction System

(71) Applicant: Chad Len Bostwick, Lubbock, TX (US)

(72) Inventor: Chad Len Bostwick, Lubbock, TX (US)

(21) Appl. No.: 19/636,192

(22) Filed: Apr. 1, 2026

Related U.S. Application Data
(60) Provisional application No. 63/790,825, filed on Apr. 18, 2025.

(51) Int. Cl. G06K 7/14; G06F 21/57

(52) U.S. Cl. CPC G06K 7/1439; G06F 21/57

(57) ABSTRACT

A system and method for context-aware QR code interaction enables dynamic, environment-sensitive responses by capturing image data of the visual surroundings of a QR code at the time of scanning. Scanning initiates a digital agent session controlled by the QR code owner. The captured image data is transmitted to an artificial intelligence module that analyzes environmental context signals including surface material, spatial object relationships, ambient lighting conditions, and proximate visual design elements. Based on the identified signals, the AI module dynamically determines and delivers a context-specific response that differs for the same QR code depending on its physical environment. A permission-gated personal data vault selectively discloses user-controlled information based on context signals and explicit user authorization. A visual attribution layer recognizes registered visual patterns surrounding the QR code and enables referral source tracking and attribution.

### CROSS-REFERENCE TO RELATED APPLICATIONS

This application claims priority to U.S. Provisional Patent Application No. 63/790,825, filed Apr. 18, 2025, the contents of which are incorporated herein by reference in their entirety.

The methods and systems described herein may be applied in contexts requiring identity-verified contextual communication, including but not limited to law enforcement interactions, access control scenarios, and emergency response situations, as further described in co-pending U.S. Provisional Application No. 63/936,756, filed Oct. 6, 2025, the contents of which are incorporated herein by reference in their entirety.

### FIELD OF THE INVENTION

The present invention relates to digital interaction systems, and more particularly to systems and methods for context-aware, AI-mediated QR code interactions employing visual environment analysis, owner-controlled digital agents, and permission-based personal data delivery.

### BACKGROUND OF THE INVENTION

Quick Response (QR) codes have become ubiquitous across commercial, governmental, and consumer applications. Despite widespread adoption, conventional QR code technology remains fundamentally static. A QR code encodes a fixed data payload—typically a URL or short text string—and delivers the same destination regardless of physical context, scan environment, or the identity of the scanning party. The QR code itself has no awareness of where it is placed, who scans it, or what surrounds it visually.

This static paradigm creates multiple limitations. First, a QR code cannot adapt its response based on its physical presentation environment, leading to generic, unadaptive user experiences. A QR code placed on a product in a retail store delivers identical content to one placed on a billboard, on a game card, or in a secure facility—even when contextually different responses would better serve the user. Second, conventional QR systems lack owner-side agency; the QR code owner cannot configure a persistent intelligent intermediary to manage interactions dynamically. Third, the visual surroundings of a QR code—brand marks, design elements, spatial relationships—carry rich informational content that existing systems entirely discard.

Prior art systems address narrow aspects of these limitations. Dual-stage QR approaches exist in payment systems and augmented reality applications, but do not employ owner-side AI agents to interpret visual surroundings. AI-enhanced QR systems generally use AI for fraud detection or encoding rather than for contextual response synthesis. Visual attribution systems exist in digital marketing but are not integrated with QR scanning workflows or personal data vaults. No known prior art discloses the combination of a two-stage scan protocol, owner-side AI agent, visual environmental context analysis, permission-gated personal data vault, and visual attribution layering in a unified QR interaction system.

There exists a clear and unmet need for a QR-based interaction system in which the physical visual environment surrounding a QR code actively determines the response delivered by an owner-controlled intelligent agent, enabling context-sensitive, privacy-preserving, and attribution-aware interactions.

### BRIEF SUMMARY OF THE INVENTION

The present invention provides a system and method for context-aware QR code interaction—referred to herein as “QR+”—that transforms conventional static QR codes into dynamic, agentive interaction portals.

A user device scans a QR code, initiating a digital agent session. The digital agent is associated with and controlled by the QR code owner. In preferred embodiments, the user device captures image data of the visual surroundings of the QR code contemporaneously with the QR scan itself, in a single scanning event requiring no additional user action. In alternative embodiments, a subsequent deliberate image capture may be prompted by the digital agent. This image data is transmitted to an artificial intelligence module operating on behalf of the QR code owner. The AI module analyzes the image data to identify environmental context signals—including surface material and texture, spatial relationships between the QR code and identified objects, ambient lighting conditions, and proximate visual design elements. Based on the identified signals, the AI module dynamically determines a context-specific response and delivers it to the user device.

The same QR code may thus deliver fundamentally different experiences depending on where it is physically presented and what surrounds it visually. A QR code embedded in a flame graphic triggers different responses than the same QR code presented on a plain white card. A QR code scanned in low-light conditions triggers different behavior than one scanned under bright overhead lighting. These differences are determined by the owner-side agent based on real visual context, not by pre-programmed static rules.

The system further includes a permission-gated personal data vault. When a scanner requests personal information, the system presents an explicit permission prompt. Data is delivered only upon user authorization, and the scope of data shared is modulated by the identified environmental context signals.

Additionally, the visual surroundings of the QR code function as an attribution layer. Registered visual patterns, frames, or design elements surrounding the QR code are recognized by the system and mapped to referral sources, enabling context-sensitive analytics, routing, and rewards delivery.

### BRIEF DESCRIPTION OF THE DRAWINGS

FIG. 1 is a system overview diagram illustrating the QR+ system component architecture, including the user device (102), QR code (104), visual context zone (106), server-side processing platform (108), owner-controlled digital agent (110), environmental context analyzer (112), response synthesizer (114), personal data vault (116), attribution registry (118), and their interconnections.

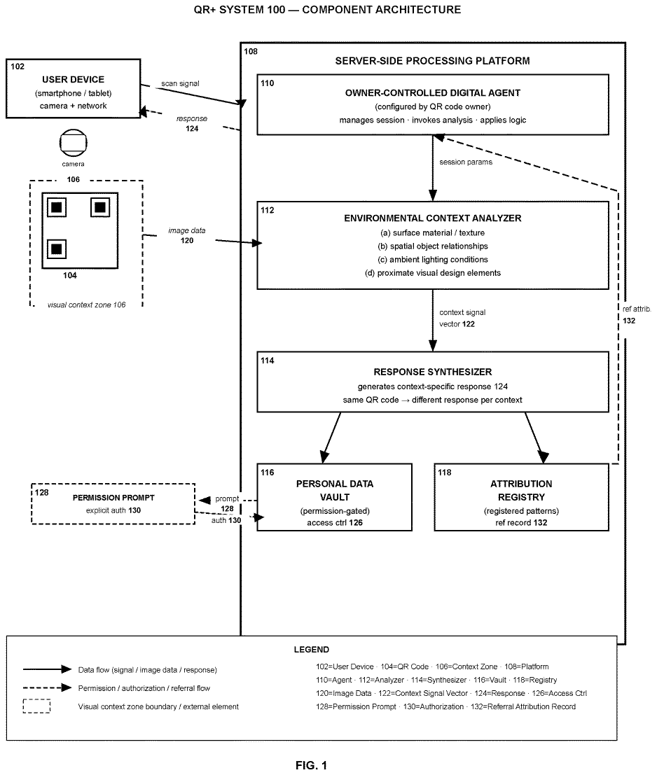

FIG. 2 is a flowchart illustrating the method steps of the QR+ interaction protocol, including QR scan initiation, browser camera API decision fork, image data capture and transmission, environmental context analysis, context-specific response synthesis, and backward-compatible static fallback path.

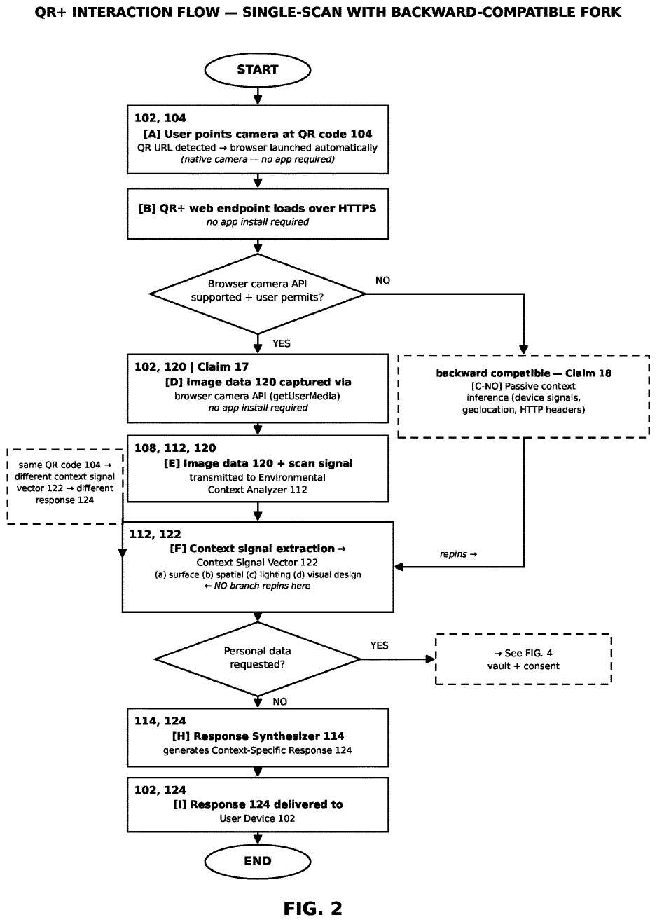

FIG. 3 is a detailed diagram of the environmental context analyzer (112), illustrating the four signal identification sub-modules: (a) surface material and texture analyzer, (b) spatial object relationship analyzer, (c) ambient lighting analyzer, and (d) visual design element recognizer, their connections to the image data input (120) and context signal vector output (122), and their relationship to the attribution registry (118).

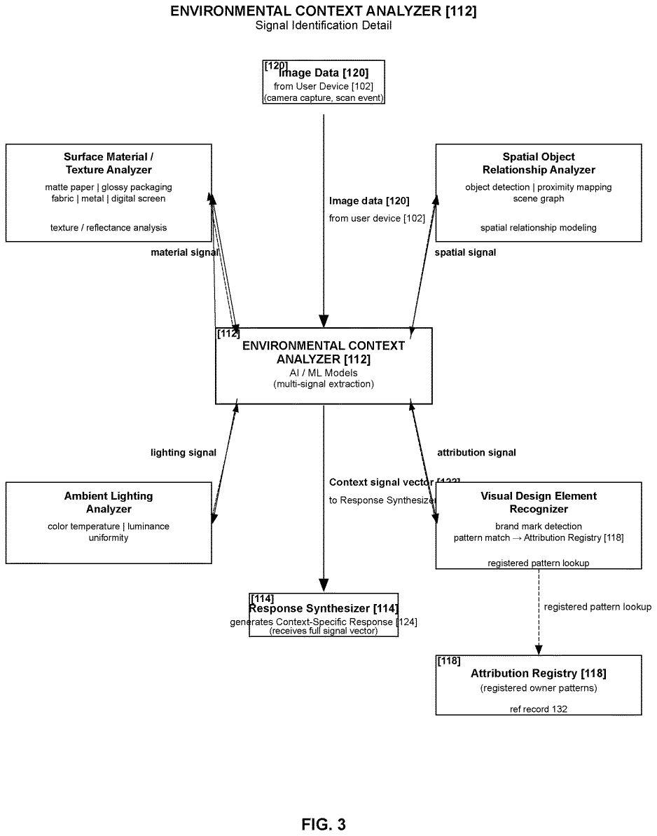

FIG. 4 is a flowchart illustrating the permission-gated personal data vault (116) interaction model, including context signal evaluation by the data vault access controller (126), permission prompt (128) presentation to the user device (102), explicit user authorization (130) decision branch, vault data release within determined disclosure scope, and graceful denial path.

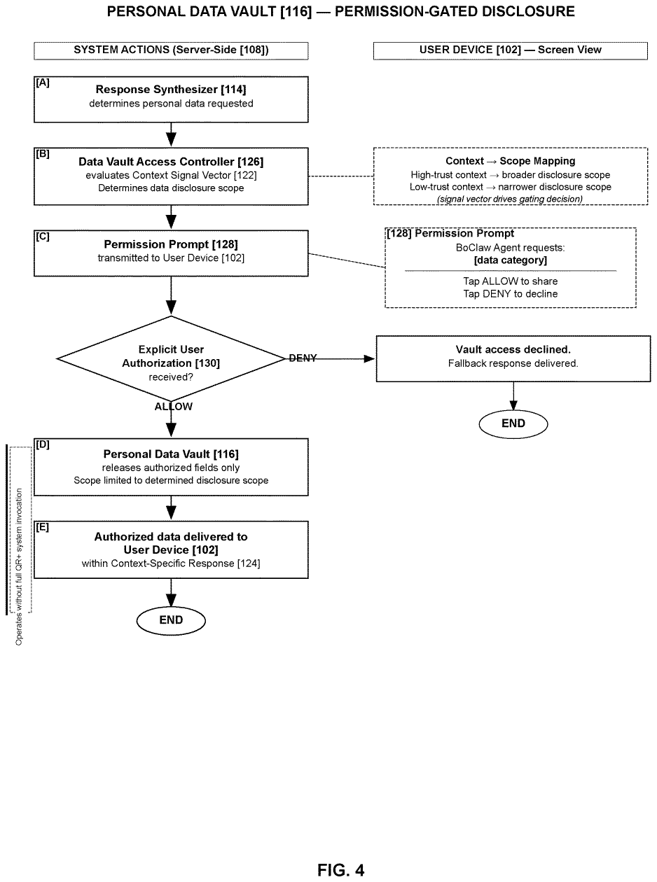

FIG. 5 is a sequence diagram illustrating the trust negotiation protocol, showing message flows between the user device (102), owner-controlled digital agent (110), and trust evaluator operating within the server-side processing platform (108), including trust level requirement broadcast, device capability and environmental attestation, trust evaluation, and modulated response delivery.

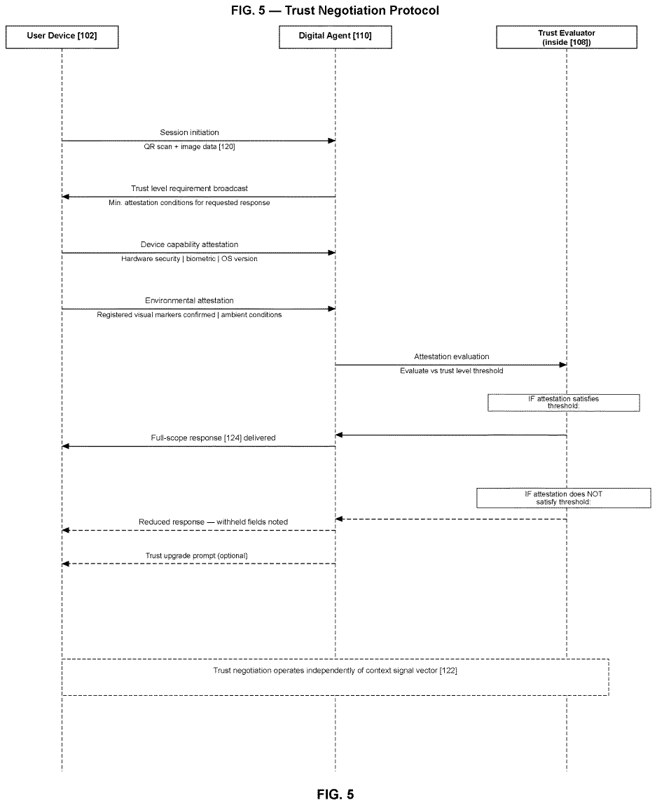

FIG. 6 is a multi-panel use case diagram illustrating exemplary deployment scenarios for the QR+ system (100), including retail product referral (Panel A), stadium event access with lighting-differentiated responses (Panel B), and permission-gated identity interaction employing the personal data vault (116), permission prompt (128), and explicit user authorization (130) (Panel C).

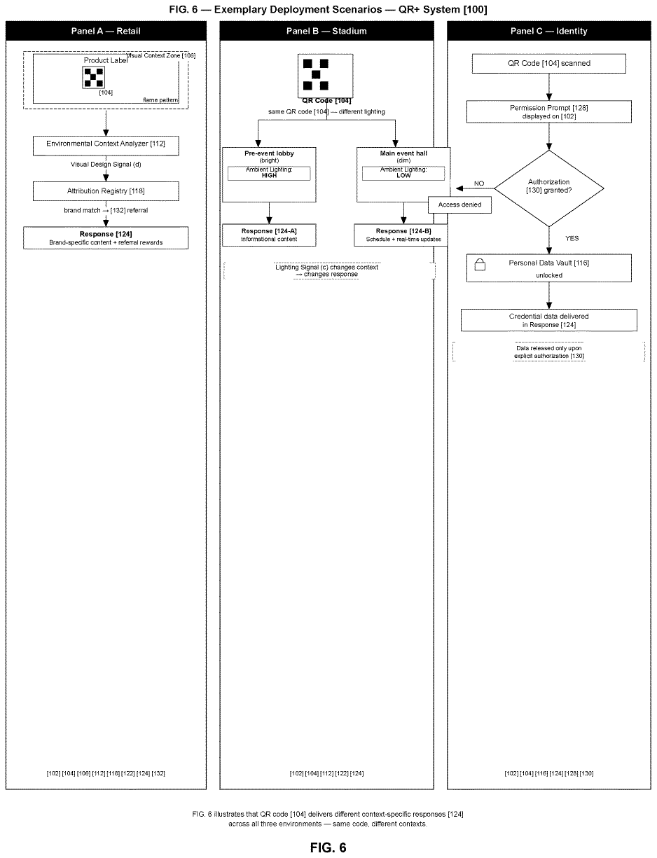

### DETAILED DESCRIPTION OF PREFERRED EMBODIMENTS

The following detailed description is presented to enable any person skilled in the art to make and use the invention. For purposes of explanation, specific embodiments are set forth to provide a thorough understanding of the present invention. However, these embodiments are not intended to be exhaustive or to limit the invention to the precise forms disclosed.

### I. System Architecture

The QR+ system 100 comprises a user device 102, a QR code 104 having an associated visual context zone 106, a server-side processing platform 108, and an owner-controlled digital agent 110. The server-side processing platform 108 includes an environmental context analyzer 112 employing machine learning models, a response synthesizer 114, a personal data vault 116, and an attribution registry 118.

The QR code 104 is a standard machine-readable optical label that encodes a unique identifier or URL associated with a digital agent session. The QR code 104 may be presented on any physical or digital medium including, but not limited to, printed labels, product packaging, event badges, playing cards, digital displays, clothing, or architectural surfaces.

The user device 102 is a computing device equipped with a camera, network connectivity, and a QR code scanning application or native camera application. The user device 102 may be a smartphone, tablet, wearable device, or dedicated scanning terminal.

The owner-controlled digital agent 110 is a software entity configured and maintained on behalf of the owner of the QR code 104. The digital agent 110 operates on the server-side processing platform 108 and is responsible for receiving scan inputs, invoking environmental analysis, synthesizing responses, managing data vault access, and applying attribution logic.

### II. Agent Session Initiation

In the first stage of the QR+ interaction protocol, the user device 102 captures and decodes the QR code 104. The decoded data initiates a connection to the server-side processing platform 108 and establishes a digital agent session associated with the QR code owner's digital agent 110. The digital agent 110 acknowledges the session and may present initial content, instructions, or a second-scan prompt to the user device 102.

The session initiation step may include device fingerprinting, timestamp recording, geolocation recording (if permitted by the user), and session token generation for continuity across multiple interactions.

### III. Visual Context Capture and Transmission

In the second stage, the user device 102 activates its camera and captures image data 120 of the visual surroundings of the QR code 104. The image data 120 captures a field of view centered on the QR code 104 and encompassing the surrounding visual environment at the scan location. The image data 120 is transmitted to the server-side processing platform 108 and received by the environmental context analyzer 112.

In preferred embodiments, the user device 102 captures the image data 120 contemporaneously with the initial QR scan in a single scanning event. The camera captures the QR code 104 and its surrounding visual context zone 106 simultaneously, without requiring a separate or deliberate second capture step. This single-scan embodiment minimizes user friction and is the preferred implementation for consumer-facing deployments. In alternative embodiments, the digital agent 110 may prompt the user device 102 to perform a subsequent deliberate image capture, for example in deployments where a wider field of view or higher image resolution of the surrounding environment is required. The claimed systems and methods encompass both single-scan and sequential-scan embodiments, as recited in the claims. In alternative embodiments, the second scan may be a separate deliberate capture prompted by the digital agent 110.

In a preferred embodiment, the user device 102 captures and transmits the image data 120 via a web browser camera application programming interface (API), such as the getUserMedia API or equivalent, executing within a web browser application on the user device 102. This embodiment requires no installation of a dedicated native application by the scanning user, enabling full QR+context-aware functionality for any user whose device supports a modern web browser operating over a secure HTTPS connection. The web browser camera API embodiment is compatible with standard QR code scanning workflows on both iOS and Android platforms, wherein the native device camera decodes the QR code 104 and launches the QR+ endpoint URL in the default web browser, which then requests camera access permissions from the user.

In an alternative embodiment providing backward compatibility with standard QR code scanning workflows, when the user device 102 does not transmit image data 120—for example, when the user declines camera access permissions or when the scanning device does not support the browser camera API—the digital agent 110 delivers a default static response without context modulation. This backward-compatible embodiment ensures that the QR+ system 100 remains accessible to all scanning users regardless of device capability or user preference, while preserving the full context-aware experience for users whose devices and permissions support image data transmission.

### IV. Environmental Context Analysis

The environmental context analyzer 112 processes the image data 120 using one or more machine learning models trained to identify environmental context signals. Environmental context signals comprise at least one of:
(a) Surface Material and Texture: The environmental context analyzer 112 identifies the material upon which the QR code 104 is presented—for example, matte paper, glossy packaging, fabric, metal, or a digital screen. Surface material identification informs the digital agent 110 about the physical medium of presentation. A QR code 104 presented on a digital display triggers different response logic than the same QR code presented on a physical printed card.
(b) Spatial Object Relationships: The environmental context analyzer 112 identifies objects present in the surrounding scene and analyzes their spatial relationships to the QR code 104. For example, the presence of a specific branded graphic, a game card design element, or a product logo at a particular spatial position relative to the QR code 104 constitutes a spatial relationship context signal.
(c) Ambient Lighting Conditions: The environmental context analyzer 112 analyzes color temperature, luminance levels, and lighting uniformity in the captured image data 120. Ambient lighting conditions may indicate the deployment environment—for example, a dimly lit venue versus a brightly lit retail environment—and modulate the digital agent's 110 response accordingly.
(d) Proximate Visual Design Elements: The environmental context analyzer 112 identifies brand marks, patterns, color schemes, glyphs, or frame elements visually proximate to the QR code 104. These design elements are compared against an attribution registry 118 of owner-registered visual patterns to determine referral source, campaign identifier, or access tier.

The environmental context analyzer 112 synthesizes the identified context signals into a context signal vector 122 that is transmitted to the response synthesizer 114.

### V. Dynamic Response Synthesis

The response synthesizer 114 receives the context signal vector 122 and the active agent session parameters from the digital agent 110. The response synthesizer 114 determines a context-specific response 124 based on the combination of the QR code identity, the session parameters, and the context signal vector 122. The context-specific response 124 may comprise any one or more of: authentication verification output, narrative content selection, anti-counterfeit validation result, in-game state modification, rewards delivery trigger, personal data disclosure, or routing redirection.

The response synthesizer 114 ensures that the same QR code 104 delivers differentiated context-specific responses 124 for different environmental contexts. Two scans of the same QR code 104 in environments producing different context signal vectors 122 will receive different context-specific responses 124.

### VI. Permission-Gated Personal Data Vault

When the context-specific response 124 includes personal data, the digital agent 110 invokes the personal data vault access controller 126. The data vault access controller 126 presents a permission prompt 128 to the user device 102 before any personal data is transmitted. The permission prompt 128 discloses the category of data requested and the purpose of disclosure.

Upon receiving explicit user authorization 130 from the user device 102, the data vault access controller 126 releases the authorized data from the personal data vault 116. The scope of data released is modulated by the context signal vector 122—for example, a scan in a verified secure environment may authorize release of more detailed personal information than a scan in an unverified public environment.

Personal data vault 116 contents are controlled exclusively by the data subject and are never disclosed without explicit authorization. The data vault 116 supports selective disclosure, releasing only the data fields authorized for the specific context-specific response 124.

The permission-gated personal data vault system described herein may operate as an independent system and method for context-modulated personal data disclosure, without requiring invocation of all components of the QR+ system 100. In this independent embodiment, a personal data vault 116 is maintained for a QR code owner and stores personal data associated with the owner. Upon receiving a scan signal and image data from a user device 102, the environmental context analyzer 112 identifies environmental context signals from the image data and determines a data disclosure scope—the set of personal data fields eligible for release in the current scanning context. The data disclosure scope is determined by the identified environmental context signals: a high-trust environmental context, such as a scan in a verified secure facility with registered visual markers confirming the deployment environment, enables a broader disclosure scope than a scan in an unverified public environment. A permission prompt 128 is then presented to the scanning user, and personal data is released from the vault 116 only upon receipt of explicit user authorization 130 and only within the determined disclosure scope. This independent method separates the vault disclosure flow from the broader response synthesis pipeline, enabling the personal data vault 116 to function as a standalone context-aware selective disclosure system.

### VII. Visual Attribution Layer

The attribution registry 118 stores a database of owner-registered visual patterns associated with specific referral sources, campaigns, partners, or access tiers. When the environmental context analyzer 112 identifies a visual design element proximate to the QR code 104 that matches a registered pattern in the attribution registry 118, a referral attribution record 132 is generated.

The referral attribution record 132 associates the scan event with the matching registered pattern, enabling the QR code owner to track which visual environments and associated referral sources are driving scan activity. Attribution records 132 may trigger rewards delivery, routing modifications, analytics logging, or commission calculations associated with the matched pattern.

In a preferred embodiment, a visual frame surrounding the QR code 104 is registered by the owner as a unique attribution identifier. Multiple QR codes embedded within different visual frames from the same owner generate distinct attribution records 132, enabling fine-grained campaign analytics without requiring separate QR codes per campaign.

### VIII. Exemplary Embodiments

Embodiment A—Branded Product Referral: A QR code 104 is embedded within a distinctive flame graphic on a product label. A first scan initiates the digital agent session. A second scan captures the flame graphic as a proximate visual design element. The environmental context analyzer 112 identifies the flame graphic in the attribution registry 118 and generates a referral attribution record 132 linking the scan to the associated brand campaign. The digital agent 110 delivers a context-specific response 124 including brand-specific content and applies referral rewards to the scanning user's account.

Embodiment B—Event Access and Environment-Aware Content: A QR code 104 is printed on an event attendee badge. In a pre-event lobby, a scan triggers informational content. Inside the main event hall, where environmental context signals include changed lighting conditions and specific event branding in the scene, the same QR code 104 triggers session-specific content and real-time schedule updates. The digital agent 110 differentiates responses based on lighting and spatial context signals without requiring the attendee to use a different QR code.

Embodiment C—Anti-Counterfeit Verification: A QR code 104 is embedded in the packaging of a limited-edition collectible. The authentic packaging includes a registered holographic visual element proximate to the QR code. The environmental context analyzer 112 identifies the holographic element and its surface texture, confirming authenticity. A counterfeit reproduction lacking the authentic surface texture generates a different context signal vector 122, and the digital agent 110 delivers a verification failure response rather than the legitimate content.

Embodiment D—Self-Sovereign Identity Interaction: A QR code 104 is assigned to a user's digital identity card. A first scan reveals public profile information. A second scan by a verified party in a secure context triggers a permission prompt 128 requesting access to credential data from the personal data vault 116. Upon explicit user authorization 130, selected credentials are disclosed. The scope of disclosure is modulated by the context signal vector 122, with higher-security contexts enabling broader data access.

### IX. Trust Negotiation Protocol

The QR+ system 100 implements a trust negotiation protocol enabling the digital agent 110 to modulate the scope and content of delivered responses based on evaluated trust signals from the scanning user device 102 and its environment. The trust negotiation protocol operates as follows.

First, upon initiation of a QR+ interaction session, the digital agent 110 broadcasts a trust level requirement to the scanning user device 102. The trust level requirement specifies the minimum attestation conditions that must be satisfied before the digital agent 110 will deliver a response of a given scope or sensitivity. Trust level requirements are configurable by the QR code owner and may vary by response type, deployment environment, or data sensitivity.

Second, the scanning user device 102 transmits device capability attestation and environmental attestation to the server-side processing platform 108. Device capability attestation characterizes the hardware and software capabilities of the user device 102—for example, whether the device is equipped with a hardware security element, biometric authentication, or a verified operating system version. Environmental attestation characterizes the scanning environment as determined from the image data 120 and other available signals—for example, confirming that the scan occurred in the presence of registered visual markers associated with a trusted deployment context, or that ambient conditions are consistent with a controlled environment.

Third, the digital agent 110 evaluates the received attestation against the trust level threshold configured for the requested response. If the received attestation satisfies the trust level threshold, the digital agent 110 delivers the full-scope context-specific response 124. If the attestation does not satisfy the threshold, the digital agent 110 delivers a reduced-scope response, withholding data fields or capabilities that require higher trust. In one embodiment, the digital agent 110 may also issue a trust upgrade prompt to the user device 102, inviting the user to perform an additional verification step to satisfy the trust level requirement.

The trust negotiation protocol operates independently of the environmental context analysis pipeline: trust level evaluation uses the environmental attestation as one input among several, but is not limited to or dependent on the context signal vector 122. This independence enables trust negotiation to function across a broad range of deployment scenarios, including those in which environmental context signals alone are insufficient to establish required trust levels.

### X. Backward Compatibility Embodiment

In embodiments where a scanning user declines camera access or the scanning device does not support web browser camera APIs, the QR+ system 100 delivers a default static response without context modulation. This backward-compatible mode ensures accessibility for all scanning users while preserving the full context-aware experience for users whose devices support image data transmission. The backward-compatible response may include a prompt inviting the user to enable camera access to receive context-sensitive content.

### XI. Law Enforcement Embodiment

In a law enforcement embodiment, a QR code 104 is associated with a vehicle or individual identity record maintained in a personal data vault 116. A law enforcement officer scanning the QR code 104 with an authorized device 602 initiates a QR+ interaction session. The digital agent 110 receives the scan signal and evaluates the trust level of the scanning device 602. The scanning device 602 transmits device capability attestation 604 confirming law enforcement authorization credentials.

The environmental context analyzer 112 processes image data 120 from the scanning device 602, identifying environmental context signals 606 consistent with a law enforcement interaction scenario —for example, registered visual markers on authorized equipment, uniform color signatures, or spatial positioning signals. The trust evaluator 608 evaluates the combined attestation against the trust level threshold configured for law enforcement access tier.

Upon satisfying the trust level threshold, the digital agent 110 invokes the data vault access controller 126 and presents a permission prompt 128 to the vehicle or individual data subject device 610. Upon receiving explicit user authorization 130, the data vault access controller 612 releases the authorized data fields 614 within the determined disclosure scope. Data released may include vehicle registration, insurance verification, license status, or other fields authorized by the data subject for disclosure in law enforcement contexts.

This embodiment demonstrates the QR+ system 100's application to identity-verified contextual communication as described in co-pending U.S. Provisional Application No. 63/936,756.

What is claimed is:

1. A computer-implemented method for context-aware QR code interaction, comprising:
receiving, by one or more processors, a first scan signal from a user device indicating initiation of a digital agent session associated with a QR code;
receiving, by one or more processors, image data captured by the user device contemporaneously with or subsequent to the first scan signal, wherein the image data comprises visual elements surrounding the QR code in the physical environment at the time of scanning;
analyzing, by an artificial intelligence module operating on behalf of the QR code owner, the image data to identify one or more environmental context signals, wherein the environmental context signals comprise at least one of:
(a) surface material or texture upon which the QR code is presented,
(b) spatial relationships between the QR code and identified objects in the surrounding scene,
(c) ambient lighting conditions or color temperature at the scan location, or
(d) visual design elements or brand marks proximate to the QR code;
dynamically determining, by the artificial intelligence module, a context-specific response based on the identified environmental context signals; and
delivering, by one or more processors, the context-specific response to the user device, wherein the delivered response differs based on the identified environmental context signals for the same QR code.

2. A system for owner-controlled, context-aware QR code interaction, comprising:
one or more processors; and
a non-transitory computer-readable medium storing instructions that, when executed, cause the system to:
maintain a digital agent associated with a QR code, wherein the digital agent is configured on behalf of and controlled by an owner of the QR code;
receive, from a scanning user device, a first signal initiating an agent session;
receive image data from the scanning user device capturing visual surroundings of the QR code at the point of scanning;
analyze the image data using machine learning to identify environmental context signals in the physical surroundings of the QR code, wherein the environmental context signals comprise at least one of:
(a) surface material or texture upon which the QR code is presented,
(b) spatial relationships between the QR code and identified objects in the surrounding scene,
(c) ambient lighting conditions or color temperature at the scan location, or
(d) visual design elements or brand marks proximate to the QR code;
synthesize the identified environmental context signals to generate a dynamic response that is unique to the identified environmental context; and
transmit the dynamic response to the scanning user device.

3. The method of claim 1, wherein identifying environmental context signals comprises analyzing the surface material upon which the QR code is presented, and wherein the context-specific response is modified based on whether the QR code is presented on a physical printed medium versus a digital display screen.

4. The method of claim 1, wherein the visual design elements proximate to the QR code function as an attribution layer, and wherein the method further comprises:
identifying a specific visual design element surrounding the QR code;
associating the identified visual design element with a referral source or attribution record; and
applying the referral attribution to routing, analytics, or rewards delivery associated with the scan event.

5. The method of claim 1, further comprising:
presenting, prior to delivering a context-specific response containing personal data, a permission prompt to the scanning user;
receiving explicit authorization from the scanning user; and
delivering personal data from a user-controlled data vault only upon receiving such authorization, wherein the scope of personal data delivered is determined at least in part by the identified environmental context signals.

6. The method of claim 1, wherein the environmental context signals include spatial relationships between the QR code and a plurality of identified objects in the surrounding scene, and wherein the context-specific response is determined by the semantic relationship between the QR code and at least two identified objects in the scene.

7. The method of claim 1, further comprising maintaining a persistent agent session across a plurality of scan events from one or more user devices, wherein agent state accumulated from prior scan events influences the context-specific response to subsequent scan events.

8. The method of claim 1, wherein the context-specific response comprises content or actions selected from a response library associated with the QR code owner, wherein selection from the response library is determined by the identified environmental context signals.

9. The system of claim 2, wherein the digital agent maintains a trust negotiation protocol with the scanning user device, comprising:
broadcasting a trust level requirement associated with the requested response;
receiving device capability and environment attestation from the scanning device; and
modulating the scope of the dynamic response based on the received attestation.

10. The system of claim 2, wherein the machine learning analysis of image data identifies a registered visual pattern surrounding the QR code from a database of owner-registered patterns, and wherein the dynamic response is uniquely determined by the combination of the QR code identity and the registered visual pattern identity.

11. The method of claim 1, wherein the environmental context signals comprise ambient lighting color temperature at the scan location, and wherein changes in the lighting color temperature between multiple scans of the same QR code trigger differentiated context-specific responses from the owner-side agent.

12. The method of claim 4, wherein the attribution layer comprises a visual frame element surrounding the QR code, and wherein the visual frame is registered by the QR code owner as a unique attribution identifier in a server-side registry.

13. A computer-implemented method for context-modulated personal data disclosure via QR code interaction, comprising:
maintaining a personal data vault associated with a QR code owner, wherein the vault stores personal data associated with the owner;
receiving, by one or more processors, a scan signal and image data from a user device, wherein the image data captures visual elements surrounding a QR code associated with the owner at the time of scanning;
analyzing, by an artificial intelligence module, environmental context signals from the image data;
determining, based on the identified environmental context signals, a data disclosure scope defining which personal data from the vault is eligible for release in the current scanning context;
presenting a permission prompt to the scanning user requesting explicit authorization to release personal data within the determined disclosure scope; and
releasing personal data from the vault to the scanning user device only upon receipt of explicit user authorization and only within the determined disclosure scope.

14. A system for trust-negotiated QR code response delivery, comprising:
one or more processors configured to:
broadcast a trust level requirement to a scanning user device upon initiation of a QR code interaction session, wherein the trust level requirement specifies minimum attestation conditions for delivery of a requested response;
receive, from the scanning user device, device capability attestation and environmental attestation describing the current scanning environment;
evaluate the received attestation against the trust level threshold; and
modulate the scope and content of the delivered response based on whether the received attestation satisfies the trust level threshold, wherein a response of greater scope or sensitivity is delivered when the attestation satisfies the threshold and a response of lesser scope is delivered when it does not.

15. The method of claim 7, wherein the persistent agent session accumulates a scan event history across a plurality of scan events from one or more user devices, and wherein the context-specific response to a subsequent scan event is further determined by the accumulated scan history of the scanning user across prior scan events associated with the same agent session.

16. The method of claim 4, wherein the referral attribution is used to calculate and distribute a compensation amount to the owner of the registered visual design element, wherein the compensation is triggered by a qualifying action taken by the scanning user subsequent to the scan event, and wherein the qualifying action and compensation amount are configurable by the owner of the registered visual design element.

17. The method of claim 1, wherein the image data is captured by the user device contemporaneously with the first scan signal in a single scanning event, without requiring a separate deliberate image capture step by the scanning user.

18. The method of claim 1, wherein, when the user device does not transmit image data, the digital agent delivers a default static response without context modulation, thereby providing backward compatibility with standard QR code scanning workflows.

19. The method of claim 1, wherein the image data is captured via a web browser camera application programming interface executing on the user device over a secure HTTPS connection, without requiring installation of a dedicated native application by the scanning user.
